(19) United States
(12) Patent Application Publication
(10) Pub. No.: US 2011/0282858 A1
(43) Pub. Date: Nov. 17, 2011

(54) Hierarchical Content Classification Into Deep Taxonomies

(75) Inventors: Ron Karidi, Herzeliya (IL); Liat Segal, Holon (IL); Oded Elyada, Tel Aviv (IL)

(73) Assignee: Microsoft Corporation, Redmond, WA (US)

(21) Appl. No.: 12/777,260

(22) Filed: May 11, 2010

(51) Int. Cl. G06F 17/30

(52) U.S. Cl. 707/709; 707/749; 707/E17.044; 707/E17.108

(57) ABSTRACT

A document may be classified by traversing a hierarchical classification tree and comparing the words in the document to words in documents representing the nodes on the classification tree. The document may be classified by traversing the classification tree and generating a comparison score based on word comparisons. The score may be used to trim the classification tree or to advance to another node on the tree. The score may be based on a scarcity or importance of individual words in the document compared to the scarcity or importance of words in the category. The result may be a set of classifications with scores for those classifications.

### BACKGROUND

Classifying documents, such as web pages, email messages, or word processor documents may be used to determine relevance for advertising and other purposes. A user's interest in a certain web page, for example, may be used to determine the user's likes and dislikes, then to provide directed advertisement to the user.

### SUMMARY

A document may be classified by traversing a hierarchical classification tree and comparing the words in the document to words in documents representing the nodes on the classification tree. The document may be classified by traversing the classification tree and generating a comparison score based on word comparisons. The score may be used to trim the classification tree or to advance to another node on the tree. The score may be based on a scarcity or importance of individual words in the document compared to the scarcity or importance of words in the category. The result may be a set of classifications with scores for those classifications.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a document classifier.

FIG. 2 is a flowchart illustration of an embodiment showing a method for analyzing a taxonomy.

FIG. 3 is a flowchart illustration of an embodiment showing a method for analyzing a document to classify.

FIG. 4 is a diagram illustration of an embodiment showing an example taxonomy.

FIG. 5 is a flowchart illustration of an embodiment showing a first method for traversing a taxonomy.

FIG. 6 is a flowchart illustration of an embodiment showing a second method for traversing a taxonomy.

### DETAILED DESCRIPTION

A document may be classified within a classification taxonomy by crawling the taxonomy and comparing the words in the document to the words represented by the taxonomy nodes. At each node, a comparison may be made to other nodes to determine the most likely node to which the crawler may move next. The result of the classification operation may be one or more classes to which the document may belong.

The classification system may compare the words of the document to words of other documents that represent the nodes in the classification taxonomy. The comparison may use the notion of importance, scarcity, or rarity to weight the words and generate a score for the comparison. Higher scores may represent a higher similarity between the document and the node, and may reflect the strength of the classification.

The classification system may traverse the taxonomy by starting with a current node, then comparing the current node to any child node of the current node. Each comparison may be made by generating a score between the current document and the documents representing the various nodes.

In one embodiment, the scores may be organized into a sorted list. The sorted list may contain each node with their respective score and may be sorted with the highest score or best match at the top of the list. The next node to be analyzed may be pulled from the top of the list. Nodes that have a lower similarity score than their parent node may be removed from consideration. In such an embodiment, many branches of a taxonomy may be evaluated to identify a best match.

In another embodiment, the taxonomy may be traversed by selecting a branch from which the most relevant term is most likely to be found. The relevance of each term may be determined by comparing the importance of the term in the parent node to the importance of the term in the child nodes. A local relevance of the terms may be used to weight the terms and select which child node, if any, to continue traversing. In such an embodiment, the taxonomy tree may be traversed in a single path.

In both embodiments, the document and the nodes may be treated as ‘a bag of words’. The bag of words may be merely all of the words in the document without regard to order. In many embodiments, the ‘words’ may be a unigram, bigram, trigram, or other group of string elements. The various n-grams may refer to character strings or word strings. In some cases, the ‘words’ may be portions of words, such as prefixes, roots, and suffixes. Throughout this specification and claims, the term ‘word’ shall be construed to be a string of characters, which may be a subset of a unigram or may be a bigram, trigram, or other n-gram, and may also include word strings or phrases.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

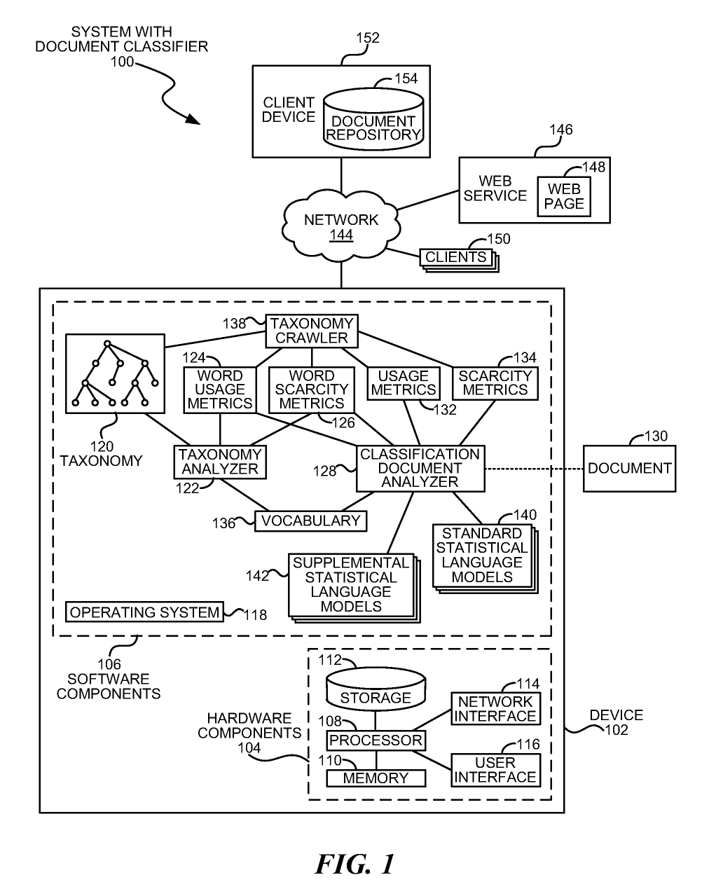

FIG. 1 is a diagram of an embodiment 100, showing a system with document classification. Embodiment 100 is a simplified example of a network environment in which a system may be capable of receiving a document and classifying the document using a taxonomy.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is an example of a document classification system. The classification system may analyze the words within a document and classify the document by comparing usage frequency and scarcity of the words in the document to the usage frequency and scarcity of the words in documents associated with each node of a taxonomy.

The taxonomy may comprise a pre-defined organization of documents. The organization may be in the form of a hierarchical structure, directed acyclic graph, or other structure. For web pages, several different taxonomies are available, such as Open Directory Project (DMOZ) and others. Many World Wide Web taxonomies may contain links to web pages that have been manually classified in a specific classification.

In an example of a hierarchical classification, a web page about travelling in Bordeaux, France may be classified in Travel>Europe>France>Bordeaux. Another web page about Bordeaux wine may be classified in Food>Wine>French>Bordeaux. In the example, the top level classifications may be “Travel” and “Food”, respectively, the second level classifications may be “Europe” and “Wine”, respectively, and so on.

Each node in the taxonomy may have one or more representative documents. In the case of World Wide Web taxonomies, the documents may be web pages. In the case of library, literary, or other types of taxonomies, the documents may be books, articles, email messages, or any other item that may contain text. In some cases, a ‘document’ may be a portion of a document, such as a chapter or section of a larger document. In other cases, a ‘document’ may be collection of multiple documents, such as an anthology of stories, series of papers, or a multi-volume book.

In order to classify a document, the words in the document are compared to words in documents associated with the nodes. The classification mechanism compares the frequency of each word with the scarcity of those words. Scarce words that are frequently used tend to indicate the content of the document and are the general mechanism by which documents are classified.

The frequency of a word may be the number of times the word is found in a document. The frequency may be determined by counting each occurrence of the word in a document in many embodiments.

The scarcity of a word may be determined in several manners, but generally reflects the inverse of frequency of that word across a corpus of documents. In one manner for determining scarcity, a count of a word occurrence in all of the documents in the taxonomy may be divided by the total number of words in the corpus. Infrequently used words may be the scarcest words.

In another method for determining word scarcity may be to refer to a statistical language model. Statistical language models may assign a probability to a word or sequence of words within a language. Statistical language models may be used for spell checking and other functions as well.

The ‘words’ used in the analysis may be individual words, or unigrams, as well as bigrams, trigrams, and other n-grams. A bigram may represent two words in a specific order, and a trigram may represent three words in a specific order. In some embodiments, a word may represent a prefix, root, or suffix of a full word. Throughout this specification and claims, the term ‘word’ may refer to any individual text element that may be used in classification. Such an element may be a unigram, bigram, trigram, or other n-gram, as well as a prefix, root, or suffix of a word.

The classification system may have several use scenarios. In one use scenario, a user may visit a particular website and an advertising system may attempt to provide advertising that may be relevant to the content of the web page. In order to determine appropriate advertising for the page, a web service may send the web page to a classification system and the classification system may attempt to classify the web page and return a classification to the web service. The web service may then find advertising that is appropriate for the classification.

In another use scenario, a user may wish to analyze their personal work history through their email account. A classification system may process each email message to generate a classification for the email message and may aggregate all of the classifications to generate a tag cloud or prioritized list of the content in the email messages.

In many embodiments, a general purpose taxonomy may be used to classify a wide range of documents, such as web pages. Other embodiments may have detailed taxonomies that are related to specific technologies, genres, or other, more narrowly focused areas. For example, a scientific taxonomy may be created for the computer science field and may be used for classifying scientific articles in the computer science realm.

The embodiment 100 illustrates a device 102 that may perform document classification. Embodiment 100 is merely one example of an architecture on which a document classification system may operate. In large scale embodiments that may process many thousands or millions of classification requests daily, the classification system may be deployed in a datacenter with many thousands of hardware platforms. In such embodiments, different functional elements described in embodiment 100 may be deployed on different devices.

The device 102 is illustrated as having a set of hardware components 104 and software components 106. The hardware components 104 may include a processor 108, random access memory 110, and nonvolatile storage 112. The hardware components 104 may also include a network interface 114 and a user interface 116.

The architecture of device 102 may be a typical architecture of a desktop or server computer. In many embodiments, the classification system may use considerable computational power for classifying against large taxonomies. Such embodiments may deploy the classification system on a server device or a group of servers in a cluster or other arrangement.

In other embodiments, smaller amounts of computational power may be used, such as when response time is not at a premium or when analyzing smaller taxonomies. In such embodiments, the classification system may be deployed on other devices, such as laptop computers, netbook computers, mobile telephones, game consoles, network appliances, or other devices.

The software components 106 may include an operating system 118 on which many applications may execute.

A taxonomy 120 may be a hierarchical structure, directed acyclic graph, or other representation of a classification system. Associated with each node of the taxonomy, may be one or more documents that represent the classification at that node. The documents may be manually selected and added to the taxonomy and may be used to represent the node.

A taxonomy analyzer 122 may process the taxonomy 120 and the associated documents to generate word usage metrics 124 and word scarcity metrics 126. In general, the word usage metrics 124 may relate to the frequency a word may be found in the taxonomy or portions of the taxonomy. The word scarcity metrics may express how infrequently the word may be used.

In some embodiments, the word frequency may be determined by counting the word in the corpus and dividing by the total number of words. Such a calculation may identify the relative importance or value of the word when doing a similarity comparison. In some embodiments, the word scarcity may be expressed as the inverse of word frequency.

In some embodiments, word scarcity may be defined for groups of nodes. In such embodiments, a group of nodes may be analyzed to determine word scarcity within that group. For example, an embodiment may analyze each node and their child nodes to determine word scarcity for that node. In such an example, each node may have different values for word scarcity. In another embodiment, the word scarcity may be determined by evaluating a node and all lower level nodes in a hierarchical taxonomy. An example of the operations of a taxonomy analyzer 122 may be found in embodiment 200 presented later in this specification.

A classification document analyzer 128 may receive a document 130, which may be known as the classification document or the document to be classified. From the document 130, the classification document analyzer 128 may develop usage metrics 132 and scarcity metrics 134 based on the words contained in the document 130.

Both the taxonomy analyzer 122 and classification document analyzer 128 may reference a vocabulary 136. The vocabulary 136 may include the ‘words’ used by the taxonomy analyzer 122 and classification document analyzer 128. The ‘words’ may include prefixes, roots, suffixes, unigrams, bigrams, trigrams, and other n-grams. For example, some embodiments may use many of the words in the English language, but may omit many commonly used words such as prepositions, conjunctions, or other words. The vocabulary 136 may include phrases and word combinations that may be identified as having specific meaning. For example, the term “search engine” may be considered a single word because the term “search engine” may have a distinct meaning separate from the terms “search” and “engine”.

Some embodiments may use standard statistical language models 140 and supplemental statistical language models 142 to determine word scarcity. In some cases, the word scarcity may be calculated by calculating word scarcity based on the corpus of documents in the taxonomy and may be further adjusted or enhanced using statistical language models. Many statistical language models may be used to determine a probability for a word or group of words. The probability may be inverted to determine scarcity for the word or phrase.

The standard statistical language models 140 may be a language model that represents common words in a language, such as American English. A supplemental statistical language model 142 may contain words that are used in specialized dialects or technologies. For example, a medical statistical language model may include medical terms that are not commonly found in a standard language model.

A taxonomy crawler 138 may crawl the taxonomy 120 using the usage metrics 132 and scarcity metrics 134 to find a classification for the document 130. Two example embodiments of the operations of the taxonomy crawler 138 may be found in embodiments 500 and 600 presented later in this specification.

The device 102 may process documents that are supplied by various sources connected to a network 144. For example, a web service 146 may supply web pages 148 to various clients 150. The web pages 148 may be classified by the device 102 to determine matches for advertising or other uses. In another use scenario, a client device 152 may have a document repository 154, such as an email mailbox or group of other documents, and the device 102 may be used to classify the documents contained in the device 152.

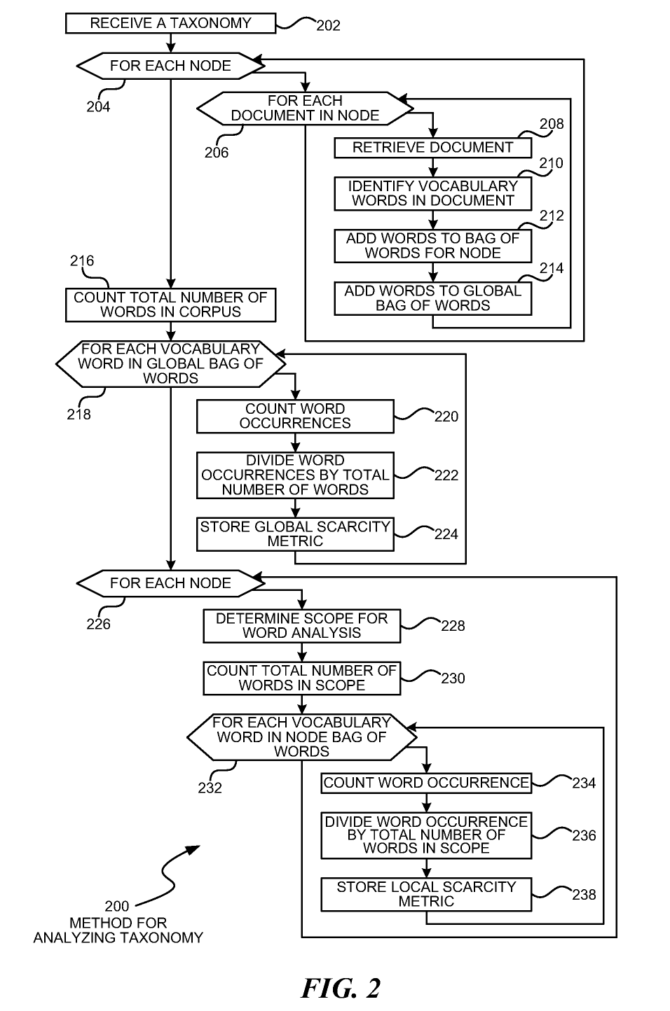

FIG. 2 is a flowchart illustration of an embodiment 200 showing a method for analyzing a taxonomy. Embodiment 400 is simplified example of a method that may be performed by a taxonomy analyzer, such as the taxonomy analyzer 122 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a method by which a taxonomy with its associated documents may be analyzed to determine scarcity metrics for words in the documents. Embodiment 200 may be used to generate both global and local scarcity metrics. A global scarcity metric may be based on the corpus as a whole, while the local scarcity metric may be based on a single node or group of nodes. A local scarcity metric may change with each node, while the global scarcity metric may be applied regardless of the node.

The operations of embodiment 200 may be performed one time when a new taxonomy is received, and may be repeated when the taxonomy is updated. Subsequent operations with the taxonomy may be performed using the scarcity metrics without having to re-analyze the taxonomy.

The taxonomy may be received in block 202.

Each node in the taxonomy may be analyzed in block 204. For each node in block 204, each document associated with the node may be processed in block 206.

For each document in block 206, the document may be retrieved in block 208. The vocabulary words may be identified in the document in block 210. The words may be added to the bag of words for the document in block 212 and to the global bag of words in block 214.

The vocabulary words may be determined by matching the text in the document to the individual words defined in the vocabulary. In some embodiments, the vocabulary words may be maintained in a table with an index assigned to each word. In such embodiments, the document may be scanned to identify a word and replace the word with the index representing the word. Such embodiments may enable faster operation by reducing text strings into integers or other data types.

In many embodiments, the vocabulary may be pre-defined with both a subset and superset of words from the language in which the documents are written. In many cases, the vocabulary may include a superset of words that represent phrases of two, three, or more words. The vocabulary may also reflect a subset of the native language when certain words that are very highly used are removed from the vocabulary. Such words may be common pronouns, nouns, verbs, adverbs, prepositions, or other words that are very frequently used.

In some cases, certain vocabulary words may be canonized into a common denominator. For example, the words “eat”, “eaten”, “ate”, and “eating” may be collapsed into a single work “eat”. Such canonization may operate differently in different languages, but in the English language, canonization may be useful in collapsing verbs.

The bag of words may be a repository that contains all of the words for a node, document, or globally for the entire corpus. The bag of words may contain words without respect to order of the words. By using a bag of words, the analysis of the documents may focus on the number of occurrences of the words, which may greatly simplify similarity comparisons between two documents or a document and a node, for example.

After processing each node and each document in each node, the total number of words in the corpus may be determined in block 216.

Each vocabulary word may be analyzed in block 218. For each vocabulary word in block 218, the word occurrences may be counted in block 220 and divided by the total number of words in block 222 to compute the global scarcity which may be stored in block 224.

The global scarcity may define the scarcity or rareness of the word within the entire corpus. In some embodiments, the global scarcity for each word may be used to process a classification document and to assign the scarcity for the words in the classification document.

Each node may be analyzed in block 226 to determine a local scarcity metric. For each node in block 226, a scope for the word analysis may be determined in block 228.

The scope of the word analysis may define the group of nodes that may be considered in determining a local scarcity metric. In some embodiments, the scope may be a single node, where the scarcity metric may be determined only from the documents associated with the node. Such an embodiment may be useful when a large number of documents are associated with each node.

In other embodiments, the scope may include the current node as well as all of the child nodes of the current node. Still other embodiments may set the scope to include the current node and all lower nodes from the current node.

The local scarcity metrics may have the effect of changing the relative importance of certain terms when the taxonomy is crawled. As a taxonomy is walked to lower nodes, the nodes may become more specific. Terms that may be important in deciding which node to crawl at a higher level may become less relevant. A use for local scarcity metrics may be found in embodiment 600 presented later in this specification.

The scope of a local scarcity metric may be determined by the number and size of documents in a node or group of nodes. In general, a scope of a single node may be too small when a limited number of documents are associated with the node. Larger numbers of documents associated with each node may produce more accurate results as the differences between documents may be minimized and a larger vocabulary may be used with more documents.

Once the scope of the local scarcity metric is determined in block 228, the total number of words in the nodes associated with the scope may be counted in block 230. Each vocabulary word may be processed in block 232. For each vocabulary work in block 232, the word occurrences may be counted in block 234 and divided by the total number of words in the scope in block 236 to produce the local scarcity metric. The local scarcity metric may be stored in block 238.

The process of embodiment 200 is a simplified example of a method by which the scarcity metrics may be calculated. Other embodiments may have more elaborate calculations and may take into account other factors, such as input from a statistical language model.

Some embodiments may include adjustments to the scarcity based on how the word was formatted or presented in a document. For example, a scarcity metric may be increased when a word may be used in a title or emphasized in bold or italics, and another word may be reduced when used in footnote or other minimized usage.

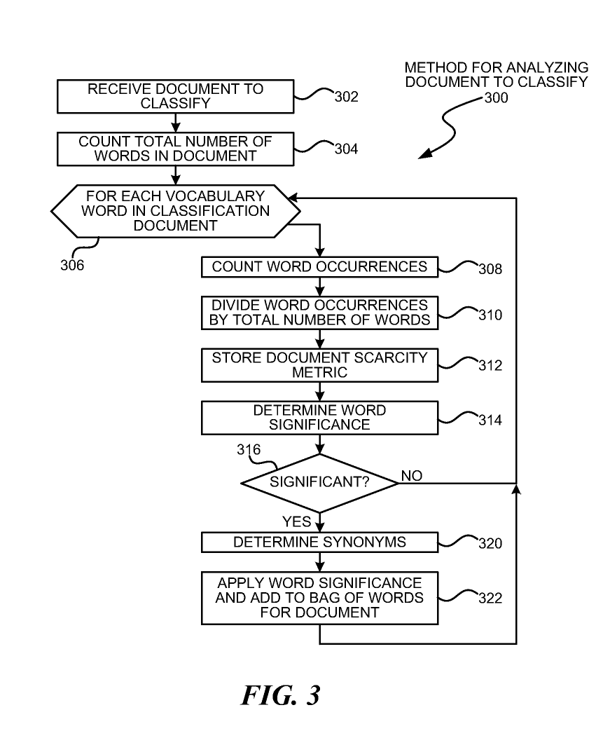

FIG. 3 is a flowchart illustration of an embodiment 300 showing a method for analyzing a classification document. Embodiment 300 is simplified example of a method that may be performed by a classification document analyzer, such as the classification document analyzer 128 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may process a classification document using similar techniques as embodiment 200 used to process documents associated with a taxonomy. Embodiment 300 may analyze each word in the document and assign a scarcity metric and frequency metric for each word based on the word's usage in the document. Additionally, embodiment 300 may add synonyms to the document for certain words which may enhance the similarity matching when crawling the taxonomy.

The document to classify may be received in block 302. The total number of words in the document may be counted in block 304. The words may be counted using the same vocabulary as in embodiment 200.

Each vocabulary word may be processed in block 306. For each vocabulary word in block 306, the word occurrences in the document may be counted in block 308 and divided by the total number of words for the document in block 310 to produce a document scarcity metric, which may be stored in block 312.

In block 314, the significance of the word may be determined in block 314. The significance may be determined by a heuristic that may define, for example, the rarity of the word from a statistical language model or the likelihood of a synonym. Some heuristics may consider the formatting or placement of the word in the document. In some cases, the metadata of the document may also be considered, such as keywords or other classification indicators.

If the word is not significant, no further processing may be performed and the process may return to block 306.

When the word is significant in block 316, a set of synonyms for the word may be determined in block 320. The word significance may be applied to the synonyms and the synonyms may be added to the bag of words representing the document. The process may return to block 306.

The operations of blocks 314 through 322 may enhance the similarity matching of the document by taking significant words that are infrequently used and providing synonyms for those words. The synonyms may increase the chances of a match when comparing the bag of words representing the document to a bag of words representing a node, for example.

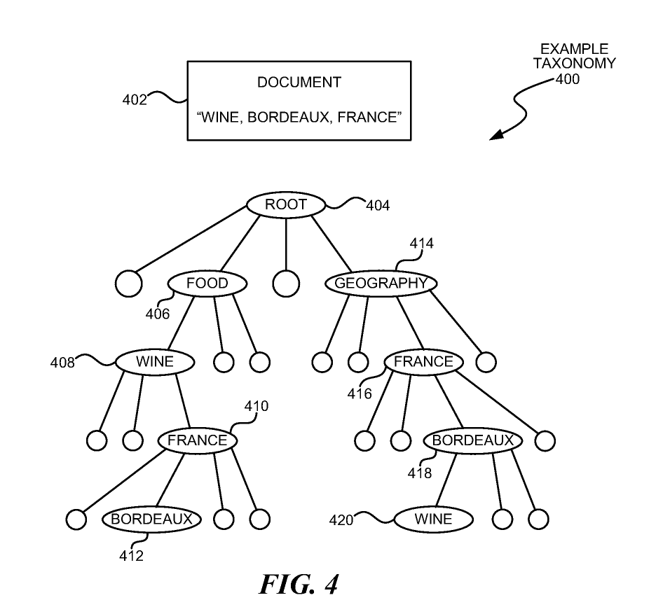

FIG. 4 is a diagram illustration of an example embodiment 400 of an example taxonomy. The example taxonomy may contain several nodes and may be used to classify a document 402.

The document 402 may contain the terms “Wine, Bordeaux, France”. When classifying the document 402, a taxonomy crawler may begin with the root node 402 and determine a similarity between the document 402 and the root node 402 and the children of the root node. Two of the child nodes may be possible matches, those nodes being “Food” at node 406 and “Geography” at node 408.

The determination of which node to select between nodes 406 and 408 may be made on the scarcity of the terms “Wine”, “Bordeaux”, and “France”. The term “Bordeaux” is most likely to be the scarcest term, followed by “France” and “Wine”. The terms in the underlying documents for each node may be used to select the node having the best similarity match.

In one embodiment, a similarity may be determined by a formula such as:

$${S}_{d , c} = {\sum }_{t}^{ } ( {TF}_{d , t} * \sqrt{{ICF}_{t}} ) * ( {TF}_{c , t} * \sqrt{{ICF}_{t}} )$$

Where S_{d,c} may be the similarity between a document and a node, TF_{d,t} may be term frequency or count for the term in the document, and ICFₜ may be the inverse category frequency or scarcity of the term. TF_{c,t} may be the term frequency for the word in the node related documents. In some embodiments, a local scarcity factor may be used in place of the global ICF in the formula above.

The similarity formula above is merely one formula that may be used to determine similarity. Other embodiments may have different methods for calculating similarity. For example, some embodiments may apply a logarithmic function to ICF.

The possible classifications for the document 402 may be along the Food>Wine>France>Bordeaux node sequence or along the Geography>France>Bordeaux>Wine. In the first sequence, the overall classification may be the geographical region of Bordeaux, France. In the second sequence, the overall classification may be “wine”, with the specific type of wine being French wines from Bordeaux.

In order to determine which classification is most similar to the document 402, a taxonomy crawler may analyze all of the words in the document, which may include additional words other than the keywords of “Wine, Bordeaux, France” to determine the best match. Words that are more related to food and wine may direct the crawler to the nodes 406, 408, 410, and 412, while words that may be related to economies, nationalities, locations, geographies, and the like may direct the crawler to the nodes 414, 416, 418 and 420.

In many cases, the most similar match may not be the bottom node in the tree. For example, the document 402 may relate primarily to French wines and may best match with node 410. The document 402 may relate primarily to the town of Bordeaux in France, which may have some reference to winemaking. In such a case, the document 402 may best match with node 418.

In embodiment 500, the crawling algorithm may calculate similarities for each child node of a current node, then may place all of the analyzed nodes in a list. The list may be sorted and the node with the highest similarity may be selected as the next node to analyze. Such an algorithm may analyze many different nodes and may traverse a taxonomy graph by jumping from one sequence of nodes to another.

In embodiment 600, a different crawling algorithm is illustrated. The algorithm of embodiment 600 may traverse a taxonomy tree by selecting the most similar child node of a current node. Embodiment 600 may use local similarities to determine which child node to select. In contrast, the algorithm of embodiment 500 may operate by using global similarities for comparisons.

Embodiments 500 and 600 are examples of different algorithms that may be performed by a taxonomy crawler. Other embodiments may have different algorithms to search for and select a similar categorization for a document.

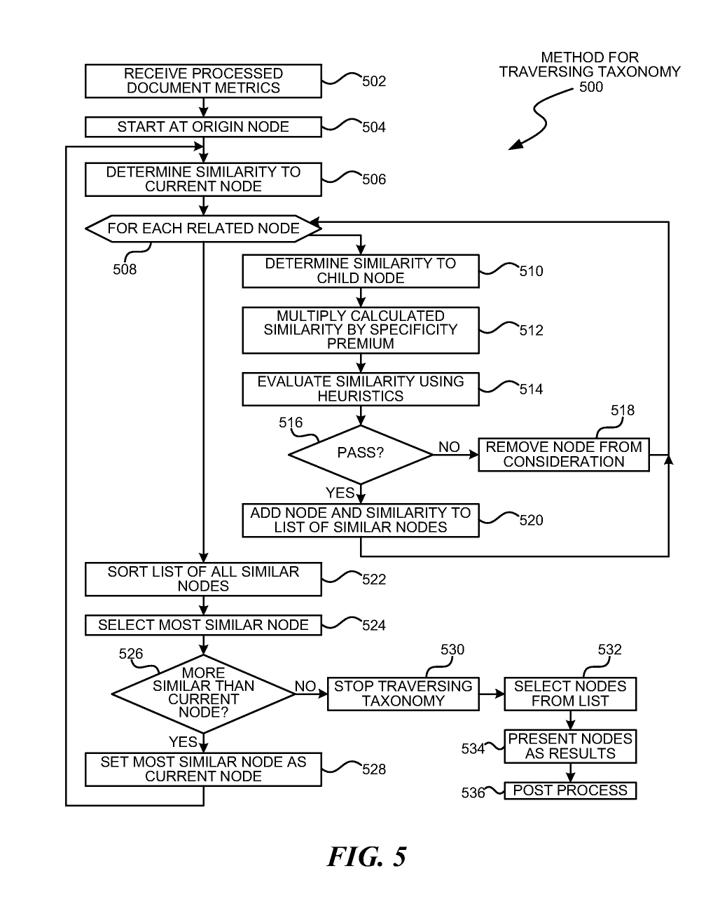

FIG. 5 is a flowchart illustration of an embodiment 500 showing a first method for traversing a taxonomy to identify a most similar classification for a document. Embodiment 500 is simplified example of a method that may be performed by a taxonomy crawler, such as the taxonomy crawler 138 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner The steps selected here were chosen to illustrate some principles of operations in a simplified form.

Embodiment 500 is one method by which a taxonomy crawler may traverse a taxonomy tree to identify a closest similarity for a given classification document. Embodiment 500 may use a sorted list of analyzed nodes and may select the closest similarity match to be the next current node to analyze. Embodiment 500 may analyze several different paths through the taxonomy graph until the best match is found.

The processed document metrics may be received in block 502. The document may be processed in a manner similar to embodiment 300 and may include word counts and word scarcity for each vocabulary word found in the document.

The starting node for traversal of the taxonomy may be set as the root node in block 504.

In block 506, the similarity between the document and the current node may be determined. The similarity may be calculated as described in embodiment 400, where each word in the vocabulary may be multiplied by the usage frequency and the scarcity for each word in the document and the node's documents. The similarity may be the sum of the calculations for each word.

Each related node to the current node may be analyzed in block 508. The related nodes in a hierarchical structure may be the child nodes of the current node. For each node in block 508, the similarity to the child node may be determined in block 512.

In block 512, the calculated similarity may be multiplied by a specificity premium. The specificity premium may be a factor that raises the similarity value for child nodes and may be useful to overcome a local maximum in the search process.

In block 514, the similarity may be evaluated using a set of heuristics. The heuristics may assist in removing candidate nodes from consideration. Examples of the heuristics may be:

$$\frac{{s}_{i}}{s} > α$$

$$\frac{{s}_{i}}{{r}_{i}} > β$$

where sᵢ may be the similarity between the document and a child node and s may be the similarity between the document and the current node. The term rᵢ may be the similarity between the document and the farthest or least similar child node. The terms α and β may be values that be used to determine whether or not to select a child node for consideration.

Another heuristic may limit the number of child nodes that may be considered. When the number may be exceeded, all of the matched child nodes may be removed from consideration. Such a heuristic may indicate that the current node is a best match and may cause the crawling to favor the current node. The illustrated heuristics may be examples of the type of heuristics that may be applied in embodiment 500. Other embodiments may have different heuristics.

If the child node being evaluated does not pass the heuristic in block 516, the node may be removed from consideration in block 518. If the node passes the heuristic in block 516, the node and its similarity may be added to a list of similar nodes in block 520. The process may return to block 508 to process additional child nodes.

When a child node is removed from consideration in block 518, the taxonomy tree may be trimmed to remove that portion of the taxonomy from further consideration.

After processing all of the child nodes in block 508, the list of passed nodes may be sorted in block 522 and the most similar node may be selected in block 524. The process of blocks 522 and 524 may allow the crawler algorithm to crawl a taxonomy by progressing through two or more paths through a taxonomy in some instances. The algorithm of embodiment 500 may process many more nodes than the algorithm of embodiment 600 where the crawling is performed by merely one path through the taxonomy.

If the most similar node from the list of passed nodes is more similar than the current node in block 526, the most similar node may be set as the current node and the process may return to block 506 to process that node and its related nodes.

If the most similar node from the list of passed nodes is not more similar than the current node in block 526, the taxonomy may stop being traversed in block 530 and one or more nodes may be selected from the list in block 532 and presented as the result in block 534. Any further processing may be performed in block 536 using the results.

The results may include both classifications and scores for the classifications. In some embodiments, two or more classifications may be presented as results, while in other embodiments, a single classification may be presented.

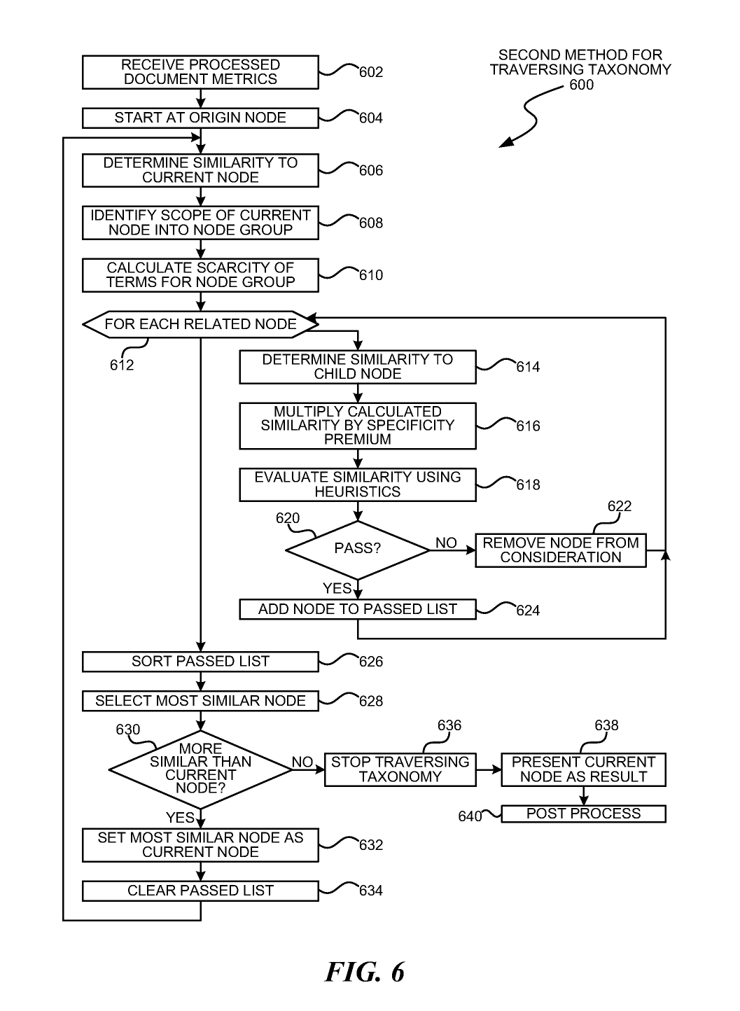

FIG. 6 is a flowchart illustration of an embodiment 600 showing a second method for traversing a taxonomy to identify a most similar classification for a document. Embodiment 600 is simplified example of a method that may be performed by a taxonomy crawler, such as the taxonomy crawler 138 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 is a method for traversing a taxonomy but is different from embodiment 500 in that embodiment 600 may traverse the taxonomy using a single path, rather than evaluating several different paths by maintaining the list of passed nodes as illustrated in embodiment 500.

Embodiment 600 may operate by using local scarcity metrics for the current node. The local scarcity metrics may provide a more accurate mechanism for selecting between several child nodes. In some embodiments, comparing a similarity between a document and the local similarities of two different nodes may not produce a meaningful comparison, especially when the document sets associated with those nodes is greatly different in size.

Embodiment 600 shares many of the same steps as embodiment 500.

The processed document metrics may be received in block 602. The origin node may be selected in block 604 as the starting node. A similarity may be determined between the document and the current node in block 606.

The scope of a node group may be determined in block 608. The node group may be the current node and its first generation child nodes, for example. In some embodiments, the node group may be the current node and two or three generations of child nodes. In still other embodiments, the node group may be the current node and all child nodes for all generations.

The word scarcity may be calculated for the node group in block 610. In some embodiments, the taxonomy may be pre-processed with local word scarcities.

For each related node in block 612, a similarity may be determined to the related node in block 614 and the similarity may be multiplied by a specificity premium in block 616. The similarity may be evaluated using heuristics in block 618 in a similar manner as in block 514 of embodiment 500.

If the current node does not pass the heuristics in block 620, the node may be removed from consideration in block 622. If the current node does pass the heuristics in block 620, the node may be added to the passed list in block 624.

The passed list may be sorted in block 626 and the most similar node may be selected in block 628.

If the most similar node is more similar than the current node in block 630, the most similar node may be set as the current node in block 632 and the pass list may be cleared in block 634. One of the differences between embodiment 600 and embodiment 500 is that embodiment 600 only evaluates the child nodes of the current nodes when considering the most similar node. In contrast, embodiment 500 may evaluate any previously passed node as a candidate for the next current node.

If the most similar node from the list of passed nodes is not more similar than the current node in block 630, the taxonomy may stop being traversed in block 636 and the current node may be presented as a single result in block 638. Any further processing may be performed in block 640 using the results.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a taxonomy comprising nodes, each of said nodes having at least one node document comprising words;
receiving a classification document to classify;
determining a vocabulary for said classification document, said vocabulary comprising words used in said classification document;
determining a usage metric for each member of said vocabulary;
determining a scarcity metric for said each member of said vocabulary;
traversing said taxonomy by a traversal method comprising:
identifying a current node;
determining a similarity between said current node and said classification, said similarity being determined from said usage metric and said scarcity metric;
for each node related to said current node, determining a related node similarity, said related node similarity being determined from said usage metric and said scarcity metric;
comparing said similarity for said current node with said related node similarity to determine a next current node; and
setting said current node to said next current node.

2. The method of claim 1, said vocabulary comprising unigrams, bigrams, and trigrams.

3. The method of claim 1, said traversal method further comprising:
determining a local scarcity metric for said current node by comparing a current node vocabulary from said current node to a child node vocabulary from said related nodes to determine a local similarity; and
using said local scarcity metric for said determining a similarity and said related node similarity.

4. The method of claim 1 further comprising:
for each of said nodes in said taxonomy, identifying a bag of words representing said node, said bag of words comprising words from said node document; and
determining a node word scarcity metric for each of said words in said bag of words for each of said nodes.

5. The method of claim 4, said node word scarcity metric being a scarcity based on a global bag of words representing all of said nodes, said word scarcity metric being a global word scarcity metric.

6. The method of claim 4, said node word scarcity metric being based on a local bag of words, said local bag of words being determined from a set of nodes related to said current node.

7. The method of claim 1, said traversal method further comprising:
placing said related node similarity into a sorted list, said sorted list being sorted by said related node similarity; and
determining said next current node by selecting a said next current node from said sorted list.

8. The method of claim 1, said taxonomy being a directed acyclic graph.

9. The method of claim 1, said traversal method further comprising:
comparing said related similarity with a set of heuristics to determine that said related similarity is able to be considered for said current node.

10. The method of claim 1, said determining a vocabulary comprising identifying at least one synonym for a first word in said classification document and adding said at least one synonym to said vocabulary.

11. The method of claim 1, said determining a vocabulary comprising:
determining a usage factor for each of said words in said vocabulary, said usage factor being determined at least in part by formatting within said classification document.

12. The method of claim 1, said scarcity metric for a word being determined by:
determining a number of occurrences of said word in said current node and said related nodes;
determining a number of words in said current node and said related nodes; and
determining said scarcity metric by dividing said number of occurrences by said number of words.

13. The method of claim 1, said usage metric for a word being determined by:
determining a number of occurrences of said word in said classification document;
determining a number of words in said classification document; and
determining said usage metric by dividing said number of occurrences by said number of words.

14. The method of claim 1, said scarcity metric being determined at least in part from a statistical language model.

15. A system comprising:
a processor;
a taxonomy comprising nodes, each of said nodes comprising related documents comprising words;
a taxonomy analyzer that:
analyzes said related documents within said taxonomy to determine word scarcity for said words in said related documents;
a classification document processor that:
receives a classification document;
determines a vocabulary from said classification document, said vocabulary comprising words contained in said classification document; and
for each of said words in said classification document, determines a usage metric;
a taxonomy crawler that:
identifies a current node in said taxonomy;
determines a similarity between said current node and said classification, said similarity being determined from said usage metric and said scarcity metric;
for each node related to said current node, determines a related node similarity, said related node similarity being determined from said usage metric and said scarcity metric;
compares said similarity for said current node with said related node similarity to determine a next current node; and
sets said current node to said next current node.

16. The system of claim 15, said classification document being a web page.

17. The system of claim 15, said taxonomy crawler that further:
determines a best match classification node for said classification document based on said similarity.

18. A method performed on a computer processor, said method comprising:
receiving a taxonomy comprising nodes, each of said nodes having at least one node document comprising words, said node documents comprising a corpus;
receiving a classification document to classify;
determining a vocabulary for said classification document, said vocabulary comprising words used in said classification document, said words comprising unigrams and bigrams;
determining a usage metric for each member of said vocabulary, said usage metric being based on a number of occurrences of said member within said classification document;
determining a scarcity metric for said each member of said vocabulary, said scarcity metric being based on a number of occurrences within said corpus;
traversing said taxonomy by a traversal method comprising:
identifying a current node;
determining a similarity between said current node and said classification, said similarity being determined from said usage metric and said scarcity metric;
for each node related to said current node, determining a related node similarity, said related node similarity being determined from said usage metric and said scarcity metric;
comparing said similarity for said current node with said related node similarity to determine a next current node; and
setting said current node to said next current node.

19. The method of claim 18, said traversal method further comprising:
placing said related node similarity into a sorted list, said sorted list being sorted by said related node similarity; and
determining said next current node by selecting a said next current node from said sorted list.

20. The method of claim 18, said similarity being made using a local scarcity.
